(19) United States
(12) Patent Application Publication
(10) Pub. No.: US 2026/0318056 A1
(43) Pub. Date: Oct. 15, 2026

(54) AERATOR

(71) Applicant: NIKLES INTER AG, Aesch (CH)

(72) Inventor: Gerhard NIKLES, Aesch (CH)

(21) Appl. No.: 19/484,149

(22) PCT Filed: May 24, 2024
(86) PCT No.: PCT/IB2024/055077

§ 371 Date: Nov. 13, 2025

(30) Foreign Application Priority Data
May 25, 2023 (IT) 102023000010605

(51) Int. Cl. E03C 1/084; B05B 1/18

(52) U.S. Cl. CPC E03C 1/084; B05B 1/18

(57) ABSTRACT

An aerator connectable to a water flow dispensing mouth for generating a nebulized-water flow has, inside a connection body, an incoming-water channeling plate adapted to divide the water flow into a plurality of accelerated micro-flows of water, and a monobloc nebulization body in which a plurality of nebulization holes is obtained, where the micro-flows of water are mixed with air. A jet-breaker peg adapted to break the micro-flow of water mixed with air is associated with each nebulization hole.

The present invention relates to an aerator for dispensing a water jet mixed with air, in particular for sanitary appliances.

In order to curb water consumption and make a water jet “softer” upon contact with the user, it is known to mix a water flow with air. For this purpose, aerators taking advantage of the Venturi effect, i.e., the suction of air caused by the acceleration of a water flow crossing a passage, can be used.

It is an object of the present invention to propose an aerator which is particularly effective in mixing a water flow with air.

It is another object of the invention to provide an aerator consisting of a small number of components, thus being reliable, simple to manufacture and assemble.

It is a further object of the present invention to provide an aerator which can be used with different water jet dispensing devices without being modified or adapted.

Such objects are achieved by an aerator according to claim 1. The dependent claims describe preferred or advantageous embodiments of the aerator.

The features and advantages of the aerator according to the invention will however become apparent from the following description of preferred embodiments thereof, given by way of non-limiting indication, with reference to the accompanying drawings, in which:

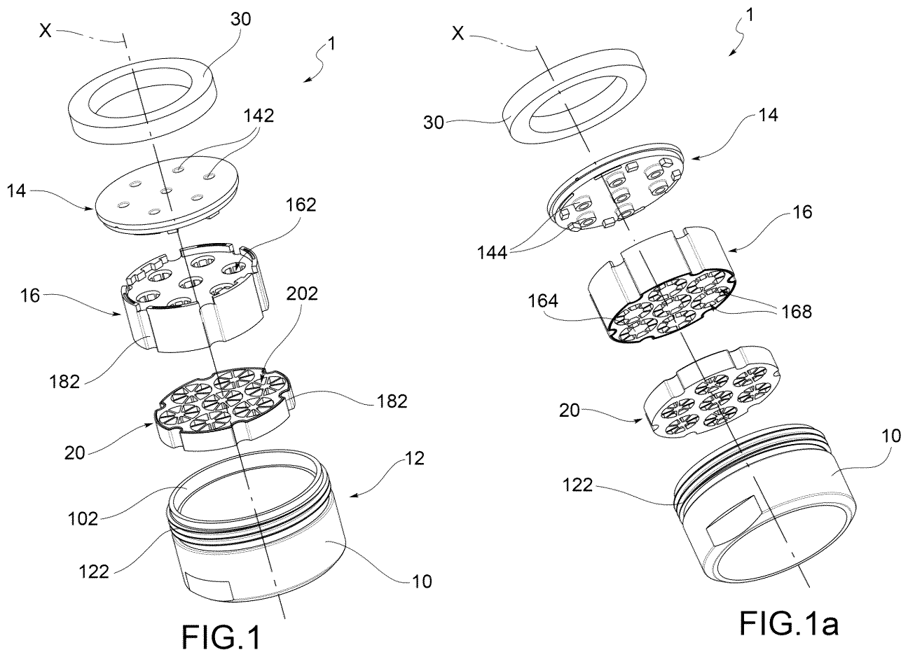

FIG. 1 and la are two exploded perspective views, a top view and a bottom view, respectively, of an aerator according to the invention;

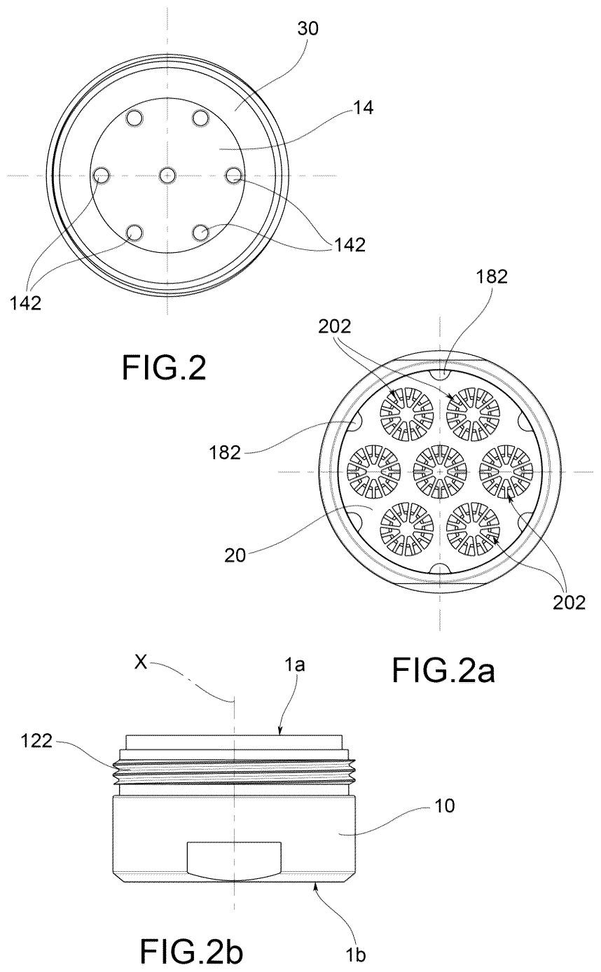

FIGS. 2, 2a, and 2b are top and bottom plan views, and an elevation view of the assembled aerator;

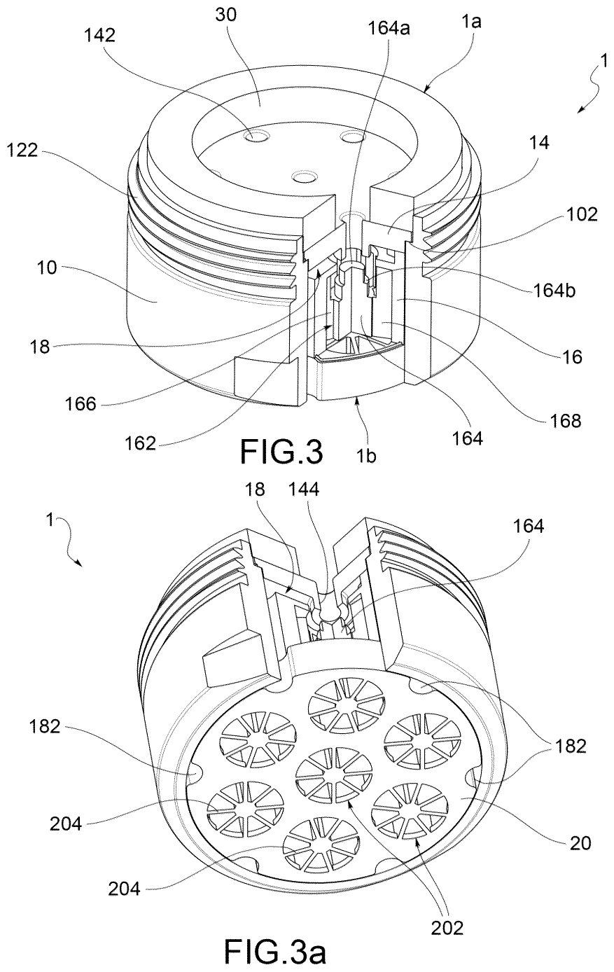

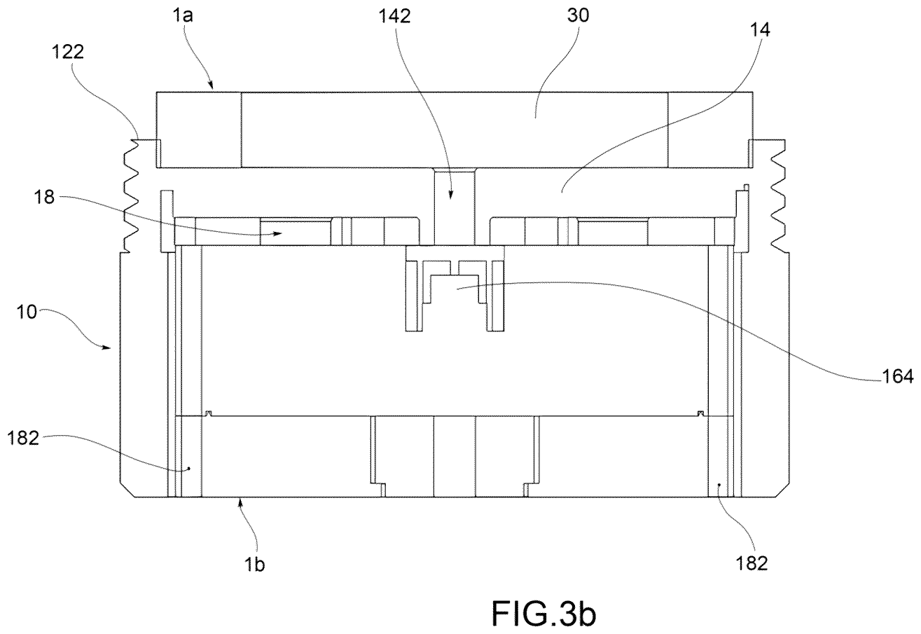

FIGS. 3 and 3a are two axial sectional perspective views of the aerator;

FIG. 3b is an axial sectional view of an alternative embodiment of the aerator;

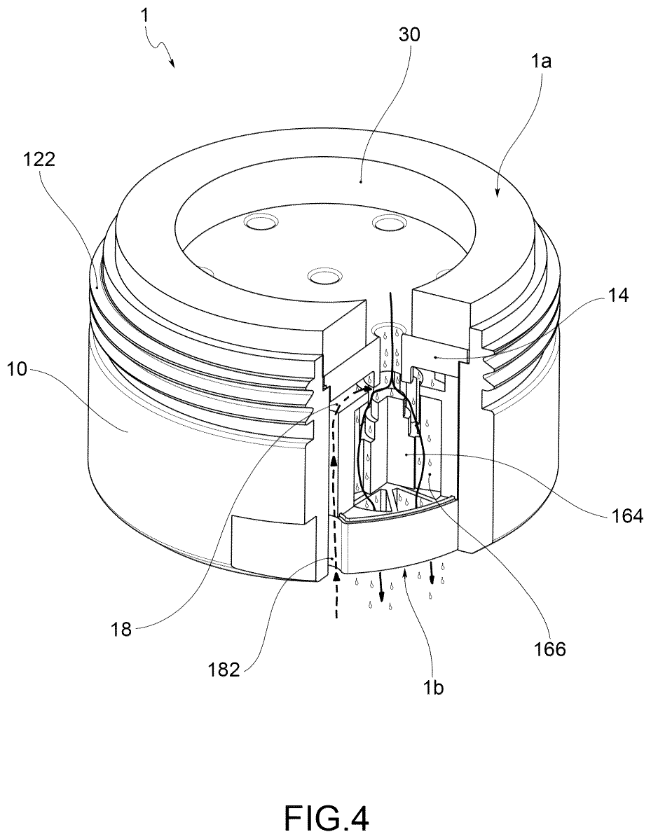

FIG. 4 is an axial sectional perspective view of the aerator in which the water and air flows are indicated;

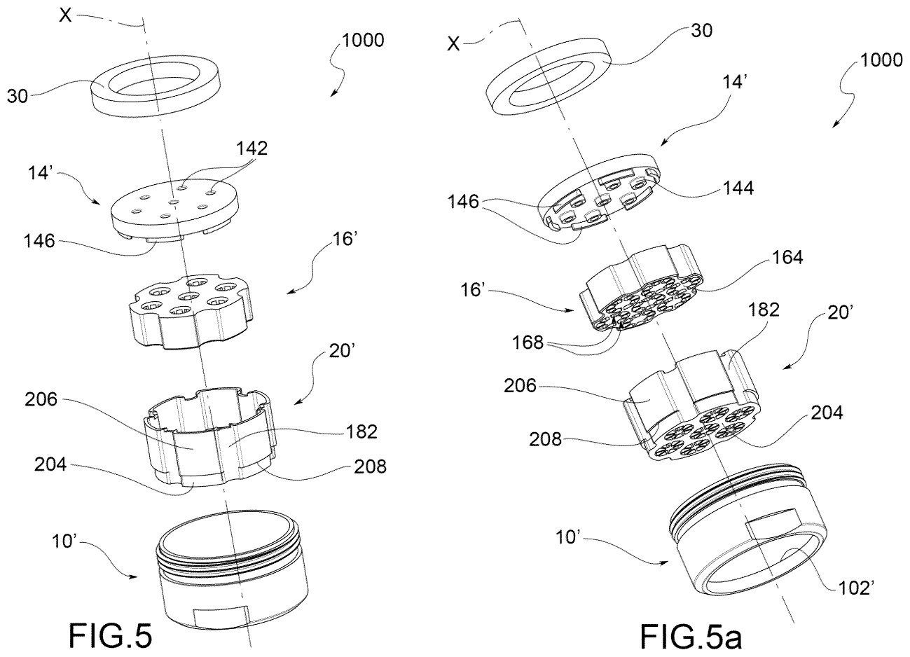

FIGS. 5 and 5a are two exploded, top and bottom perspective views, respectively, of an aerator according to the invention, in an alternative embodiment;

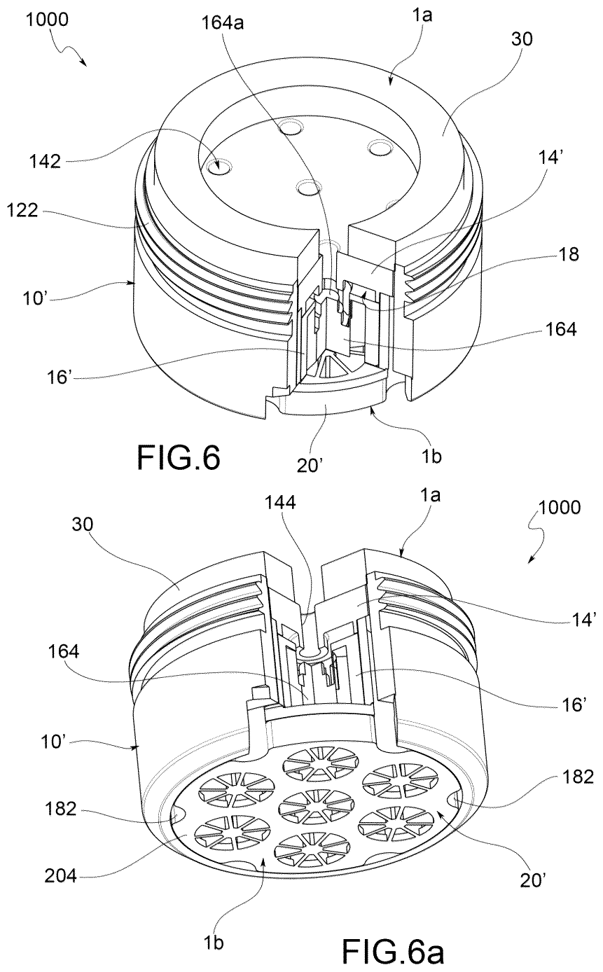

FIGS. 6 and 6a are two perspective, axial section views of the aerator in FIGS. 5 and 5a;

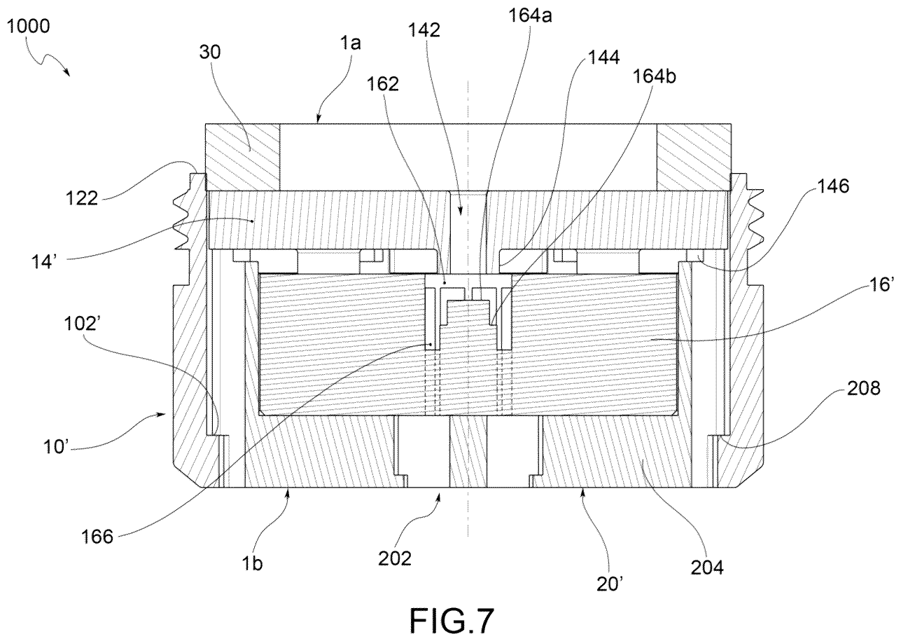

FIG. 7 is an axial section of the aerator in FIGS. 5, 5a, 6, 6a;

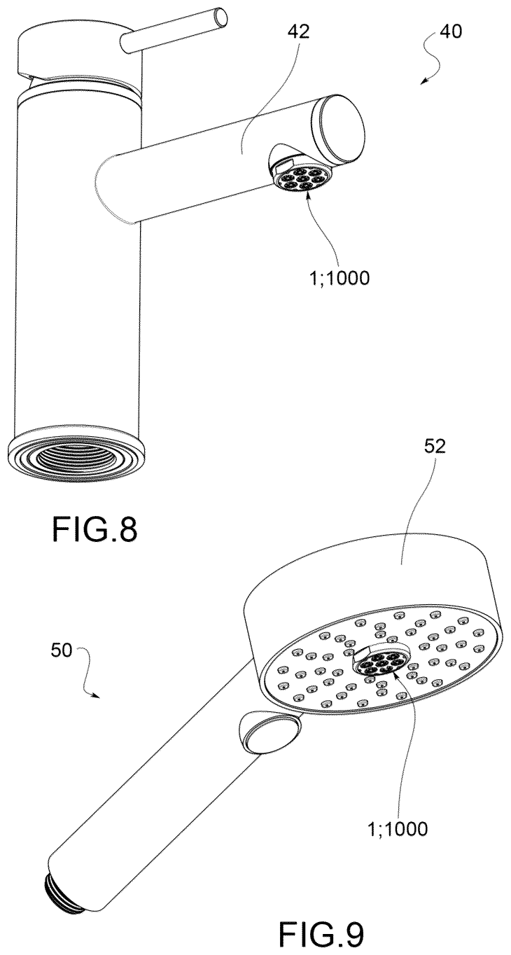

FIGS. 8, 9, 10 and 11 are just as many examples of water jet dispensing devices incorporating the aerator according to the invention.

In the following detailed description of embodiments of the aerator according to the invention, elements common to such embodiments are indicated by the same reference numerals.

In FIGS. 1-4, an aerator according to the invention is indicated as a whole by reference numeral 1.

The aerator 1 is connectable to a water flow dispensing mouth for generating a nebulized-water flow, i.e., an aerated water flow, i.e., mixed with air.

The aerator extends about an aerator axis X. The aerator axis X also identifies the direction of the water flow crossing the aerator, from a proximal end la for the ingress of the water flow into the aerator, to a distal end 1b for the exit of the nebulized-water flow.

In a general embodiment, aerator 1 Comprises an outer body 10 having connection means 12 for a sealing connection to the dispensing mouth. For example, the outer body 10 is a substantially cylindrical body, made of a metal material, for example.

In an embodiment, the connection means 12 comprise a threaded neck 122 adapted to be screwed onto a threaded end of the dispensing mouth.

An incoming-water channeling plate 14 and a monobloc nebulization body 16 are arranged, or obtained, inside the outer body 10 in an overlapping relationship with respect to the aerator axis X.

A plurality of water inlet holes 142 adapted to divide the water flow from the dispensing mouth into a plurality of accelerated micro-flows of water is obtained in the incoming-water channeling plate 14.

In other words, when the proximal end of the outer body 10 is in fluid connection with the water flow dispensing mouth, the water flow entering into the aerator hits the channeling plate 14 and, as it enters into the water inlet holes 142, it is divided into a plurality of flow portions, or micro-flows, increasing in speed due to the reduction of the passage section.

The monobloc nebulization body 16, for example substantially cylindrical in shape, is positioned downstream of the channeling plate 14, with respect to the direction of the water flow, and is spaced apart from the channeling plate so that a thin air suction chamber 18 is formed between the channeling plate and the nebulization body. The air suction chamber 18 is defined “thin” because the height thereof, i.e., its extension along the aerator axis X, is significantly less than the diameter of its base.

In other words, the facing surfaces of the channeling plate 14 and of the nebulization body 16, for example both substantially flat, delimit an air suction chamber 18 therebetween and with the outer body 10, in fluid communication with the external environment.

A plurality of nebulization holes 162 is obtained in the nebulization body 16. Each nebulization hole 162 is made at, and coaxially to, a respective water inlet hole 142. Therefore, the nebulization hole 162 is adapted to receive, from the water inlet hole 142, a respective micro-flow of water mixed with air sucked into the suction chamber 18 due to the Venturi effect.

In other words, each pair of water inlet hole 142 and respective nebulization hole 162 forms a path for a micro-flow of water which, due to the acceleration thereof while crossing the air suction chamber 18, sucks air from the external environment, thus mixing therewith.

A jet-breaker peg 164 adapted to break the micro-flow of water mixed with air is obtained in each nebulization hole 162.

Due to such a jet-breaker peg 164, the aerated water flow exiting from the nebulization hole 162 is opened and further nebulized so that the overall aerated water flow exiting from the aerator is perceived as an even and continuous flow, and not as a set of small concentrated flows.

In an embodiment, the jet-breaker peg 164 extends coaxially to the hole axis of the respective nebulization hole 162 so as to form a substantially annular peripheral passage 166 into which the micro-flow of water mixed with air is conveyed.

In an embodiment, each water inlet hole 142 is delimited, at the end facing the nebulization body 16, by a guide neck 144 extending from the channeling plate 14. As it can be particularly seen in the sections of FIGS. 3 and 3a, each nebulization hole 162 has an inlet mouth configured to receive the distal end of the guide neck 144.

In other words, the inlet mouth of each nebulization hole 162 has a greater diameter than the outer diameter of the guide neck 144 so that the entire micro-flow of water crossing the water inlet hole 142 is conveyed into the respective nebulization hole 162, in any case leaving a radial passage for the ingress of air from the air suction chamber 18 into the nebulization hole 162.

In an embodiment, each jet-breaker peg 164 is formed by axial sections of increasing diameter from the aerator in the outlet direction of the respective micro-flow of water mixed with air so as to form a sequence of jet-breaker planes. For example, each jet-breaker peg has a circular flat top surface 164a and one or more annular surfaces 164b having increasing diameter which enlarge and nebulize the water and air flow hitting the jet-breaker peg 164.

Each jet-breaker peg 164 can be supported by the nebulization body 16 by virtue of two or more radial connection ribs 168.

In an embodiment shown in FIGS. 1-4, the aerator 1 further comprises a nebulized-water outlet plate 20 positioned downstream of, and in contact with, the nebulization body 16. A plurality of outlet openings 202 is obtained in this nebulized-water outlet plate 20. Each of such outlet openings 202 is obtained at, and coaxially to, a respective nebulization hole 162.

In an embodiment, a plurality of radial ribs 204 for channeling the nebulized-water flow is obtained in each outlet opening 202.

The effect of the outlet openings 202 is that of guiding, i.e., channeling, the flows of aerated water exiting from the nebulization holes 162 so that such flows, albeit not being particularly concentrated and clearly separate from each other, as mentioned above, are substantially directed parallel to the aerator axis X, e. g., downwards.

In an embodiment, the air suction chamber 18 communicates with the external environment by means of a plurality of suction channels 182 obtained in the nebulization body 16 and/or between the nebulization body 16 and the outer body 10, parallel to the sidewall of the outer body 10, as in the example shown.

According to an embodiment, the channeling plate 14 and the nebulization body 16 are inserted with positive coupling and/or force fitting into the outer body 10. For example, the outer body 10 is made of brass.

In an embodiment, the channeling plate 14, the nebulization body 16 and the nebulized-water outlet plate 20 are superimposed and welded to one another, e.g., by electrowelding.

In an embodiment, the channeling plate 14 rests on an annular step 102 obtained in the outer body 10.

Therefore, when the channeling plate 14, the nebulization body 16 and the nebulized-water outlet plate 20 are superimposed and welded to one another so as to form a single nebulization assembly, such an assembly is supported in the outer body 10 by virtue of the channeling plate 14 resting on the annular step 102.

In an alternative embodiment shown in FIG. 3b, the outer body 10 and the channeling plate 14 are obtained in one piece in a single body, e.g., made of plastic material.

In an embodiment, the side of the channeling plate 14 adapted to face the dispensing mouth acts as a support seat for an annular sealing element 30 adapted to make the connection with the dispensing mouth hermetic.

In an embodiment, the channeling holes 142 and the respective nebulization holes 162 are evenly distributed in the cross section of aerator 1. For example, as in the embodiment shown, seven channeling holes 142 and respective nebulization holes 162, positioned at the vertices and in the center of a hexagon, are obtained in the channeling plate 14 and the nebulization body 16, respectively.

FIGS. 5-7 show an aerator 1000 according to an alternative embodiment, which differs from the aerator 1 in FIGS. 1-4 only due to the coupling means between the elements which form the aerator. However, the single elements and the functions thereof are substantially the same as those described above for the aerator in FIGS. 1-4 and will not be described again for simplicity of disclosure. Only the differences related to the embodiment in FIGS. 1-4 will be highlighted.

In this embodiment, the outer body 10′ forms an inner annular step 102′ in the inner side surface thereof, close to the distal end 1b of the outer body 10′.

The nebulized-water outlet plate 20′ is cup-shaped, i.e., comprises a base 204 in which the outlet openings 202 are obtained, and a substantially cylindrical side wall 206 which extends upwards from the base 204.

Suction channels 182 are obtained in the side wall 206.

Moreover, an undercut 208 adapted to rest on the inner annular step 102′ of the outer body is obtained on the side wall 206, close to the base 204.

The nebulization body 16′ is sized so as to be housed in the nebulized-water outlet plate 20′, resting on the upper surface of the base 204.

Here, the channeling plate 14′ can simply rest on the upper edge of the side wall 206, so as to allow however, for example by virtue of spacers 146 with which the channeling plate 14′ is provided, the passage of drawn air from the suction channels 182 into the air suction chamber 18 between the channeling plate 14′ and the nebulization body 16′ underneath.

In an embodiment, in order to avoid undesired movements of the channeling plate 14′, the latter can be constrained, e.g., by welding or gluing, to the edge of the side wall 206.

In an embodiment shown in the Figures, aerator 1 has the same shape and dimensions as a conventional jet-breaker aerator of the type to be screwed onto the outlet mouth of a common faucet.

For example, FIG. 8 shows a faucet 40 comprising a water dispensing pipe 42 and an aerator 1; 1000 as described above, connected to such a dispensing pipe 42 by screwing, for example.

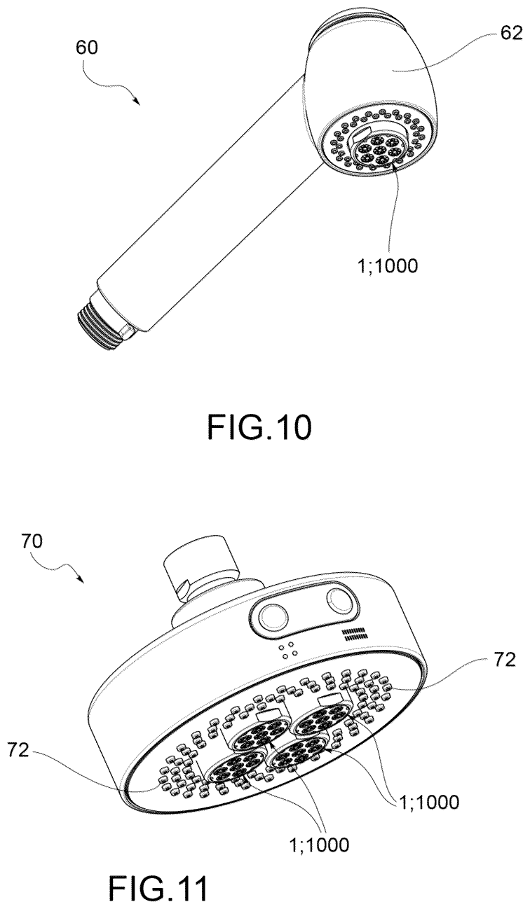

FIGS. 9 and 10 show examples of a hand shower 50 and kitchen faucet sprayer 60, respectively, comprising a dispensing head 52; 62 in which a seat is obtained in fluid communication with a water jet supply duct. An aerator 1; 1000 as described above is housed in such a seat.

FIG. 11 shows an example of a shower head 70 in which, in addition to being provided with a crown 72 of conventional nozzles, the head 70 is provided with one or more (four here) aerators 1; 1000 according to the invention.

Those skilled in the art may make changes and adaptations to the embodiments of the aerator according to the invention or can replace elements with others which are functionally equivalent in order to meet contingent needs without departing from the scope of the appended claims. Each of the features described above as belonging to a possible embodiment can be implemented irrespective of the other embodiments described.

What is claimed is:

1. An aerator connectable to a water flow dispensing mouth for generating a nebulized-water flow, the aerator comprising:
an outer body having connection means for a sealing connection with the dispensing mouth,
and, inside the outer body,
an incoming-water channeling plate, a plurality of water inlet holes adapted to divide the water flow from the dispensing mouth into a plurality of accelerated micro-flows of water being obtained in the incoming-water channeling plate;
a monobloc nebulization body positioned downstream of the incoming-water channeling plate and spaced apart from the incoming-water channeling plate so that facing surfaces of the incoming-water channeling plate and of the monobloc nebulization body mutually delimit, with the outer body, an air suction chamber in fluid communication with an external environment, a plurality of nebulization holes being obtained in the monobloc nebulization body, each nebulization hole of the plurality of nebulization holes being obtained at and coaxially to a respective water inlet hole of the plurality of water inlet holes so as to receive, from the respective water inlet hole, a respective micro-flow of water mixed with air sucked into the air suction chamber due to the Venturi effect, a jet-breaker peg adapted to break the micro-flow of water mixed with air being obtained in each nebulization hole of the plurality of nebulization holes.

2. The aerator of claim 1, wherein the jet-breaker peg extends coaxially to a hole axis so as to form a substantially annular peripheral passage in which the micro-flow of water mixed with air is conveyed.

3. The aerator of claim wherein each water inlet hole of the plurality of water inlet holes is delimited, at an end facing the monobloc nebulization body, by a guide neck extending from the incoming-water channeling plate, and wherein each nebulization hole of the plurality of nebulization holes has an inlet mouth configured to receive a distal end of the guide neck.

4. The aerator of claim 1, wherein each jet-breaker peg is formed by axial sections having increasing diameter in an outlet direction from the aerator of the respective micro-flow of water mixed with air so as to form a sequence of jet-breaker planes.

5. The aerator of claim 1, further comprising a nebulized-water outlet plate positioned downstream of, and in contact with, the monobloc nebulization body, a plurality of outlet openings being obtained in the nebulized-water outlet plate, each outlet opening of the plurality of outlet openings being obtained at and coaxially to a respective nebulization hole.

6. The aerator of claim 5, wherein a plurality of radial ribs for channeling the nebulized-water flow is obtained in each outlet opening of the plurality of outlet openings.

7. The aerator of claim 1, wherein the air suction chamber communicates towards the external environment by a plurality of suction channels obtained in the monobloc nebulization body and/or between the monobloc nebulization body and the outer body, parallel to a sidewall of the outer body.

8. The aerator of claim 5, wherein the nebulized-water outlet plate is cup-shaped, the nebulized-water outlet plate comprising a base in which the outlet openings are obtained, and a substantially cylindrical side wall which extends from the base, the monobloc nebulization body being housed inside the nebulized-water outlet plate.

9. The aerator of claim 8, wherein the air suction chamber communicates towards the external environment by a plurality of suction channels obtained in the substantially cylindrical side wall of the nebulized-water outlet plate.

10. The aerator of claim 1, wherein the incoming-water channeling plate and the monobloc nebulization body are inserted with positive coupling and/or force fitting into the outer body.

11. The aerator of claim 1, wherein the incoming-water channeling plate rests on an annular step obtained in the outer body.

12. The aerator of claim 8, wherein the nebulized-water outlet plate rests on an inner annular step obtained in an inner side surface of the outer body, close to a distal end of the outer body.

13. The aerator of claim 1, wherein the outer body and the incoming-water channeling plate are obtained in one piece in a single body, optionally the single body being made of plastic material.

14. The aerator of claim 1, wherein the connection means comprise a threaded neck adapted to be screwed onto a threaded end of the dispensing mouth.

15. The aerator of claim 1, wherein a side of the incoming-water channeling plate adapted to face the dispensing mouth acts as support seat for an annular sealing element adapted to make the connection with the dispensing mouth hermetic.

16. The aerator of claim 1, wherein the water inlet holes and the respective nebulization holes are evenly distributed in a cross section of the aerator.

17. The aerator of claim 16, wherein seven water inlet holes and respective nebulization holes positioned at vertices and in a center of a hexagon are obtained in the incoming-water channeling plate and the monobloc nebulization body, respectively.

18. A faucet comprising a water dispensing pipe and the aerator of claim 1, connected to the water dispensing pipe.

19. A hand shower or a kitchen faucet sprayer comprising a dispensing head in which a seat in fluid communication with a water jet supply duct is obtained, wherein the aerator of claim 1 is housed in the seat.

20. A shower head comprising one or more aerators according to claim 1.
